(19) United States
(12) Patent Application Publication
(10) Pub. No.: US 2023/0291078 A1
(43) Pub. Date: Sep. 14, 2023

(54) BATTERY

(71) Applicant: Prime Planet Energy & Solutions, Inc., Tokyo (JP)

(72) Inventors: Yuta TANAHASHI, Kobe-shi (JP); Kazutaka MITA, Kobe-shi (JP)

(21) Appl. No.: 18/181,563

(22) Filed: Mar. 10, 2023

(30) Foreign Application Priority Data
Mar. 14, 2022 (JP) 2022-039648

(51) Int. Cl. H01M 50/489; H01M 50/538; H01M 50/103; H01M 4/62; H01M 4/485

(52) U.S. Cl. CPC H01M 50/489; H01M 50/538; H01M 50/103; H01M 4/623; H01M 4/485

(57) ABSTRACT

A battery disclosed herein has a wound electrode body. A positive electrode has a positive electrode active material layer including a lithium-transition metal complex oxide as a positive electrode active material and a positive electrode binder. A length of the positive electrode active material layer in a width direction is 100 mm or larger. A negative electrode has a negative electrode active material layer containing graphite as a negative electrode active material. A separator has a base material layer, a heat-resistant layer opposing the positive electrode, and an adhesive layer opposing the negative electrode. A content of ceramic particles in the heat-resistant layer is 90 mass % or higher. A content of adhesive layer binder in the adhesive layer is 15 mass % or higher.

### CROSS REFERENCE TO RELATED APPLICATION

This application claims the benefit of priority to Japanese Patent Application No. 2022-039648 filed on Mar. 14, 2022. The entire contents of this application are hereby incorporated herein by reference.

### BACKGROUND OF THE DISCLOSURE

### 1. Field

The present disclosure relates to a battery.

### 2. Background

A battery is conventionally known which has a wound electrode body resulting from laying up a band-shaped positive electrode provided with a positive electrode active material layer on a positive electrode collector, and a band-shaped negative electrode provided with a negative electrode active material layer on a negative electrode collector, across a band-shaped separator, and by winding a resulting stack in a longitudinal direction. For instance, WO 2021/060010 describes a squashed flat-shaped wound electrode body obtained through press molding of a cylindrical electrode body. In WO 2021/060010 an electrode tab group is provided at an end portion of a flat-shaped wound electrode body in the width direction, and is electrically connected to an electrode terminal.

### SUMMARY

In the flat-shaped wound electrode body, in a lapse of time from press molding to insertion into the battery case there arise forces, that urge restoring of the cylindrical shape (this phenomenon will hereafter be referred to as “springback”). Ordinarily this tendency becomes more prominent as dimensions of the wound electrode body increase. Upon occurrence of springback, the inter-electrode distance between positive and negative electrodes widens, resistance increases, and charge carrier precipitation tends to occur. It is moreover difficult to accommodate, in the battery case, a wound electrode body in which springback has occurred, and to electrically connect the wound electrode body to electrode terminals, which may translate into lowered production efficiency.

The present disclosure has been arrived at in the light of the above considerations and it is an object thereof to provide a battery in which the occurrence of springback is suppressed.

The present disclosure provides a battery that has: a flat-shaped wound electrode body in which a band-shaped positive electrode, a band-shaped negative electrode and a band-shaped separator are wound in a longitudinal direction; and a battery case that accommodates the wound electrode body. The positive electrode has a positive electrode active material layer including a lithium-transition metal complex oxide as a positive electrode active material, and a positive electrode binder; and a length w1 of the positive electrode active material layer in a width direction perpendicular to the longitudinal direction is 100 mm or larger. The negative electrode has a negative electrode active material layer containing graphite as a negative electrode active material. The separator has a base material layer, a heat-resistant layer opposing the positive electrode, and an adhesive layer opposing the negative electrode. The heat-resistant layer contains ceramic particles and a heat-resistant layer binder such that a mass ratio of the ceramic particles relative to a total mass of the heat-resistant layer is 90 mass % or higher. The adhesive layer contains an adhesive layer binder such that a mass ratio of the adhesive layer binder relative to a total mass of the adhesive layer is 15 mass % or higher.

Studies by the inventors have newly revealed that it is mainly the negative electrode that causes springback in the wound electrode body. Specifically, studies by the inventors have revealed that the positive electrode active material (lithium-transition metal complex oxide) is harder than the negative electrode active material (graphite), and exhibits a smaller displacement against compressive forces. It was deemed that, as a result, changes such as an increase in thickness after press molding are unlikely to occur, and that the influence on springback is small. By contrast, the negative electrode active material (graphite) is relatively bulkier than the positive electrode active material, and exhibits a larger displacement against compressive forces. It was considered that, as a result, thickness increases readily after press molding, and the influence on springback is significant. On the basis of the above findings, the adhesive layer of the separator in the battery disclosed herein is set to oppose the negative electrode. The adhesive layer is bonded (for instance pressure-bonded) to the negative electrode for instance by press molding. Through bonding of the adhesive layer of the separator to the particle interface of the negative electrode active material it becomes possible to curtail forces that would cause the negative electrode active material to spread outward. The art disclosed herein allows as a result suppressing the occurrence of springback.

Studies by the inventors have further revealed that when not only the negative electrode but also the positive electrode is bonded to the separator, so-called gas entrainment might occur in that upon generation of gas in the interior of the wound electrode body, for instance during initial charging of the battery or when the battery is overcharged, that generated gas is not readily discharged out of the wound electrode body (i.e. gas releasability of the wound electrode body decreases).

In the battery disclosed herein, therefore, the heat-resistant layer of the separator is set to oppose the positive electrode. As a result, heat shrinkage of the separator at high temperatures can be suppressed, and bonding of the positive electrode and the separator can be reduced, and excellent gas releasability be realized. Also, the occurrence of gas entrainment can be suppressed. Such being the case the art disclosed herein allows providing a battery having a wound electrode body of improved reliability and in which the occurrence of springback is suppressed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective-view diagram illustrating schematically a battery according to an embodiment;

FIG. 2 is a schematic longitudinal cross-sectional diagram along line II-II in FIG. 1;

FIG. 3 is a schematic longitudinal cross-sectional diagram along line III-III in FIG. 1;

FIG. 4 is a schematic transversal cross-sectional diagram along line IV-IV in FIG. 1;

FIG. 5 is a perspective-view diagram illustrating schematically a plurality of wound electrode bodies attached to a sealing plate;

FIG. 6 is a perspective-view diagram illustrating schematically a wound electrode body to which a respective positive electrode second collector and a respective negative electrode second collector are attached;

FIG. 7 is a schematic diagram illustrating the configuration of a wound electrode body;

FIG. 8 is a plan-view diagram illustrating schematically a wound electrode body;

FIG. 9 is an enlarged-view diagram illustrating schematically an interface between a positive electrode plate, a negative electrode plate and a separator;

FIG. 10 is a plan-view diagram illustrating a negative electrode-side surface of a separator;

FIG. 11 is a plan-view diagram illustrating a negative electrode-side surface of a separator according to a first variation;

FIG. 12 is a plan-view diagram illustrating a negative electrode-side surface of a separator according to a second variation;

FIG. 13 is a plan-view diagram illustrating a negative electrode-side surface of a separator according to a third variation; and

FIG. 14 is a plan-view diagram illustrating a negative electrode-side surface of a separator according to a fourth variation, on a negative electrode side.

### DETAILED DESCRIPTION OF THE PREFERRED EMBODIMENTS

Some embodiments of the art disclosed herein will be explained next with reference to accompanying drawings. Any features other than the matter specifically set forth in the present specification and that may be necessary for carrying out the present specification (for instance the general configuration and production process of a battery that do not characterize the present disclosure) can be regarded as instances of design matter, for a person skilled in the art, based on known art in the relevant technical field. The art disclosed herein can be implemented on the basis of the disclosure of the present specification and common technical knowledge in the relevant technical field. In the present specification, the notation “A to B” for a range signifies a value “equal to or larger than A and equal to or smaller than B”, and is meant to encompass also the meaning of being “preferably larger than A” and “preferably smaller than B”.

The reference symbol X in the figures of the present specification denotes a “width direction”, the reference symbol Y denotes a “depth direction”, and the reference symbol Z denotes a “height direction”. Further, the reference symbol F in the depth direction X denotes “front” and Rr denotes “rear”. The reference symbol L in the width direction Y denotes “left” and R denotes “right”. The reference symbol U in the height direction Z denotes “up”, and D denotes “down”. These directions are defined however for convenience of explanation, and are not intended to limit the manner in which the battery disclosed herein is installed.

In the present specification the term “battery” is a term denoting power storage devices in general capable of extracting electrical energy, and encompasses conceptually primary batteries and secondary batteries. In the present specification, the term “secondary battery” denotes a power storage device in general that can be repeatedly charged and discharged as a result of the movement of charge carriers across a pair of electrodes (positive electrode and negative electrode) via an electrolyte. Such secondary batteries include not only so-called storage batteries such as lithium ion secondary batteries and nickel-metal hydride batteries, but also capacitors such as electrical double layer capacitors. Embodiments of a lithium ion secondary battery will be explained next.

1. Battery Structure

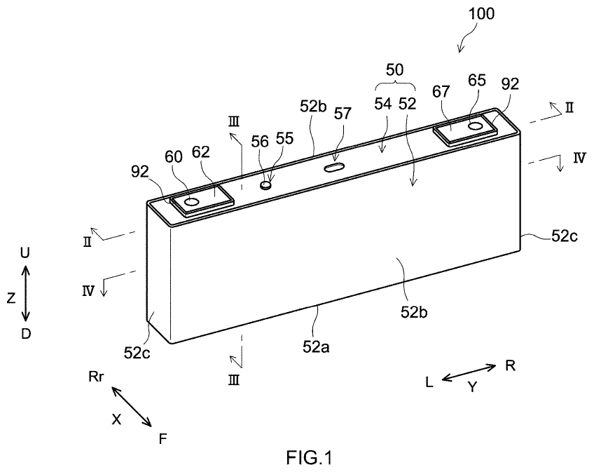

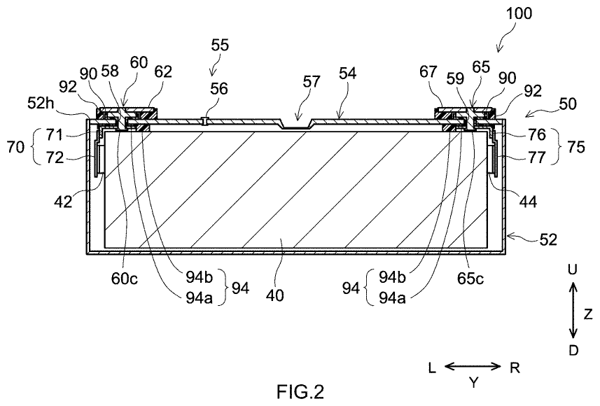

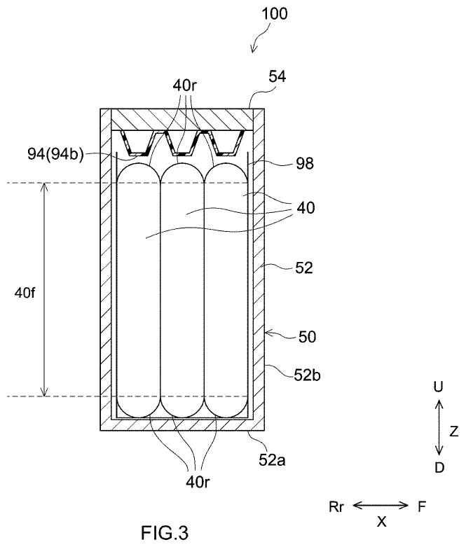

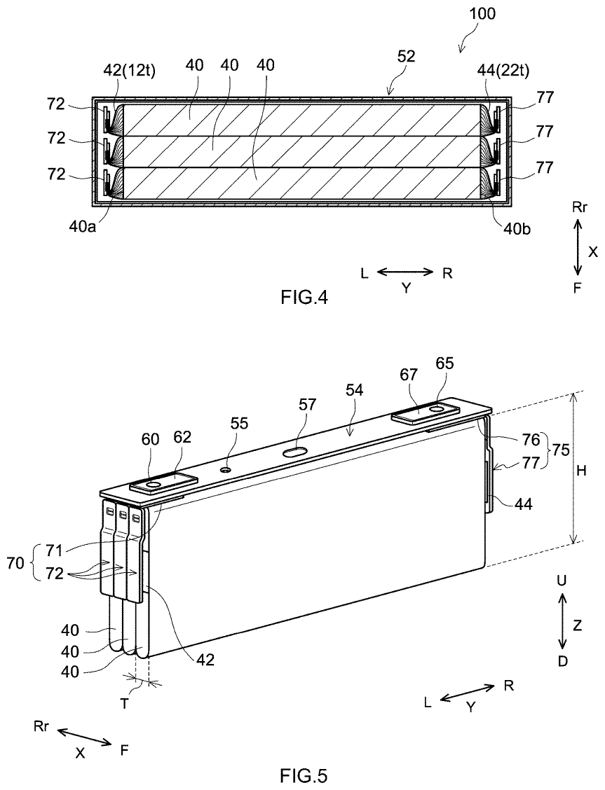

FIG. 1 is a perspective-view diagram illustrating schematically a battery 100 according to the present embodiment. FIG. 2 is a schematic longitudinal cross-sectional diagram along line II-II in FIG. 1. FIG. 3 is a schematic longitudinal cross-sectional diagram along line III-III in FIG. 1. FIG. 4 is a schematic transversal cross-sectional diagram along line IV-IV in FIG. 1.

As illustrated in FIG. 2, the battery 100 according to the present embodiment includes a wound electrode body 40 and a battery case 50 that accommodates the wound electrode body 40. Although not illustrated in the figures, an electrolyte solution is further accommodated in the interior of the battery case 50. That is, the battery 100 is a nonaqueous electrolyte secondary battery. A concrete configuration of such a battery 100 will be explained next.

The battery case 50 is a housing that accommodates the wound electrode bodies 40. As illustrated in FIG. 1, the external shape of the battery case 50 in the present embodiment is a flat and bottomed cuboid shape (angular shape). A conventionally known material can be used in the battery case 50, without particular limitations. The battery case 50 may be made of a metal. Examples of the material of the battery case 50 include aluminum, aluminum alloys, iron, iron alloys and the like.

As illustrated in FIG. 1 and FIG. 2, the battery case 50 includes an exterior body 52 and a sealing plate 54. The exterior body 52 is a flat bottomed square container having an opening 52h in the top face. As illustrated in FIG. 1, the exterior body 52 has a planar and substantially rectangular bottom wall 52a, a pair of long side walls 52b extending upward in the height direction Z, from the long sides of the bottom wall 52a, and a pair of short side walls 52c extending upward in the height direction Z, from the short sides of the bottom wall 52a. The sealing plate 54 is a planar and substantially rectangular plate-shaped member that plugs the opening 52h of the exterior body 52. The outer peripheral edge portion of the sealing plate 54 is joined (for instance welded joining) to the outer peripheral edge portion of the opening 52h of the exterior body 52. Accordingly, the interior of the battery case 50 is hermetically sealed. The sealing plate 54 is provided with a liquid injection hole 55 and a gas discharge valve 57. The liquid injection hole 55 is a through-hole provided for the purpose of injecting an electrolyte solution into the sealed battery case 50. The liquid injection hole 55 is sealed with a sealing member 56 after injection of the electrolyte solution. The gas discharge valve 57 is a thin-walled portion designed to break (to open) when a large amount of gas is generated inside the battery case 50, and to discharge that generated gas.

Electrolyte solutions that are utilized in conventionally known batteries can be used, without particular limitations, as the electrolyte solution. For instance a nonaqueous electrolyte solution in which a supporting salt is dissolved in a nonaqueous solvent can be used as the electrolyte solution. Examples of the nonaqueous solvent include carbonate solvents such as ethylene carbonate, dimethyl carbonate and ethyl methyl carbonate. Among the foregoing, the nonaqueous solvent preferably includes both a linear carbonate and a cyclic carbonate. Examples of the supporting salt include fluorine-containing lithium salts such as LiPF₆. The electrolyte solution may contain additives as necessary.

A positive electrode terminal 60 is attached to one end (left side in FIG. 1 and FIG. 2) of the sealing plate 54 in the width direction Y. The positive electrode terminal 60 is connected to a plate-shaped positive electrode external conductive member 62, on the outside of the battery case 50. A negative electrode terminal 65 is attached to the other end (right side in FIG. 1 and FIG. 2) of the sealing plate 54 in the width direction Y. A plate-shaped negative electrode external conductive member 67 is attached to the negative electrode terminal 65. The positive electrode external conductive member 62 and negative electrode external conductive member 67 are connected to other batteries and external devices via an external connecting member (bus bar or the like).

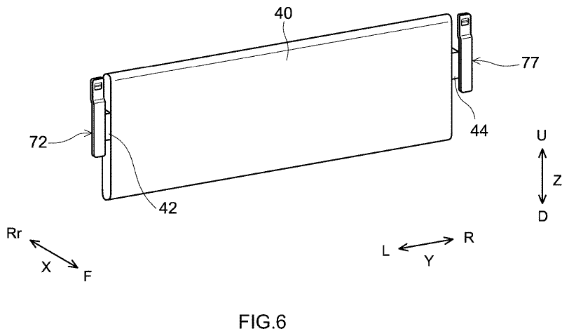

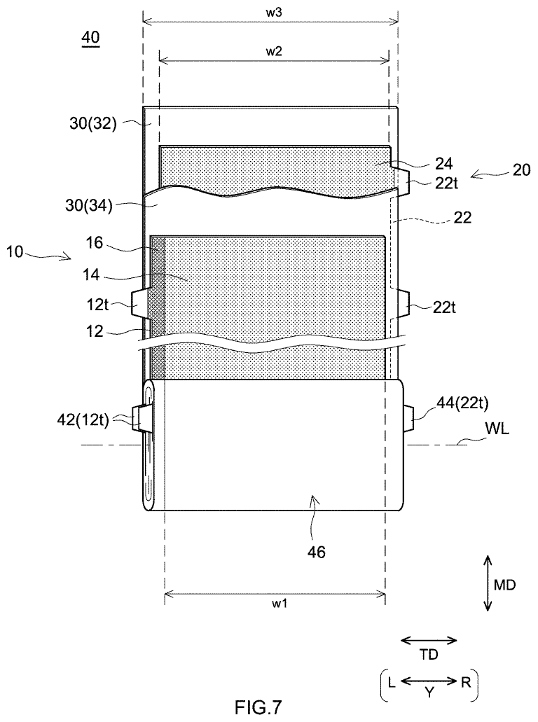

FIG. 5 is a perspective-view diagram illustrating schematically a plurality of wound electrode bodies 40 attached to the sealing plate 54. In the battery 100 according to the present embodiment, a plurality (more specifically, three) of wound electrode bodies 40 are accommodated in the battery case 50, as illustrated in FIG. 3 to FIG. 5. Although the detailed structure thereof will be described further on, each wound electrode body 40 has a positive electrode tab group 42 and a negative electrode tab group 44 (see also FIG. 6 and FIG. 7).

As illustrated in FIG. 4, the electrode tab groups (positive electrode tab group 42 and negative electrode tab group 44) are bent in a state of being joined to the electrode collectors (positive electrode collector 70 and negative electrode collector 75. Each positive electrode tab group 42 of the plurality of wound electrode bodies 40 is connected to the positive electrode terminal 60 via the positive electrode collector 70. The positive electrode collector 70 is accommodated inside the battery case 50. As illustrated in FIG. 2 and FIG. 5, the positive electrode collector 70 has a positive electrode first collector 71 which is a plate-shaped conductive member extending, in the width direction Y, along the inner surface of the sealing plate 54, and a plurality of positive electrode second collectors 72 which are plate-shaped conductive member extending in the height direction Z. A lower end portion 60c of the positive electrode terminal 60 is inserted into the battery case 50 through a terminal insertion hole 58 of the sealing plate 54, and is connected to the positive electrode first collector 71 (see FIG. 2). The positive electrode second collectors 72 are connected to respective positive electrode tab groups 42 of the wound electrode bodies 40. As illustrated in FIG. 4 and FIG. 5, the positive electrode tab groups 42 are bent so that the positive electrode second collectors 72 and one side face 40a of the wound electrode bodies 40 oppose each other. The upper end portion of the positive electrode second collectors 72 and the positive electrode first collector 71 become electrically connected to each other as a result.

Moreover, each negative electrode tab group 44 of the plurality of wound electrode bodies 40 is connected to the negative electrode terminal 65 via the negative electrode collector 75. Here, the connection structure on the negative electrode side is substantially identical to the connection structure on the positive electrode side described above. Specifically, as illustrated in FIG. 2 and FIG. 5, the negative electrode collector 75 has a negative electrode first collector 76 which is a plate-shaped conductive member extending in the width direction Y along the inner surface of the sealing plate 54, and a plurality of negative electrode second collectors 77 which are plate-shaped conductive member extending in the height direction Z. A lower end portion 65c of the negative electrode terminal 65 is inserted into the battery case 50 through a terminal insertion hole 59, to be connected to the negative electrode first collector 76 (see FIG. 2). Each of the plurality of negative electrode second collectors 77 is connected to a respective negative electrode tab group 44. As illustrated in FIG. 4 to FIG. 5, the negative electrode tab group 44 is bent so that the negative electrode second collectors 77 and the other side face 40b of the wound electrode bodies 40 oppose each other. The upper end portion of the negative electrode second collectors 77 and the negative electrode first collector 76 become electrically connected to each other as a result. A metal having excellent conductivity (aluminum, aluminum alloy, copper, copper alloy or the like) can be suitably used as the electrode collectors (positive electrode collector 70 and negative electrode collector 75).

In the battery 100 various insulating members are further attached in order to prevent conduction between the wound electrode bodies 40 and the battery case 50. Specifically, a respective external insulating member 92 is interposed between the positive electrode external conductive member 62 (negative electrode external conductive member 67) and the outer surface of the sealing plate 54 (see FIG. 1 and FIG. 2). As a result it becomes possible to prevent conduction between the positive electrode external conductive member 62 or the negative electrode external conductive member 67 and the sealing plate 54. A respective gasket 90 is fitted to each of the terminal insertion holes 58, 59 of the sealing plate 54 (see FIG. 2). As a result it becomes possible to prevent conduction between the positive electrode terminal 60 (or negative electrode terminal 65), inserted into the terminal insertion holes 58, 59, and the sealing plate 54.

Further, a respective internal insulating member 94 is disposed between the positive electrode first collector 71 (or the negative electrode first collector 76) and the inner surface of the sealing plate 54. The internal insulating member 94 includes a plate-shaped base portion 94a interposed between the positive electrode first collector 71 (or the negative electrode first collector 76) and the inner side surface of the sealing plate 54. As a result it becomes possible to prevent conduction between the positive electrode first collector 71 or the negative electrode first collector 76 and the sealing plate 54. Each internal insulating member 94 is further provided with a protruding portion 94b that protrudes from the inner surface of the sealing plate 54 towards the wound electrode bodies 40 (see FIG. 2 and FIG. 3). As a result it becomes possible to restrict the movement of the wound electrode bodies 40 in the height direction Z, and to prevent direct contact between the wound electrode bodies 40 and the sealing plate 54.

In addition, the plurality of wound electrode bodies 40 are accommodated inside the battery case 50 in a state of being covered with an electrode body holder 98 (see FIG. 3) made up of an insulating resin sheet. This allows preventing as a result direct contact between the wound electrode bodies 40 and the exterior body 52. The material of each of the above-described insulating members is not particularly limited, so long as the material has predetermined insulating properties. As an example, there can be used synthetic resin materials, for instance polyolefin resins such as polypropylene (PP) and polyethylene (PE), as well as fluororesins such as perfluoroalkoxyalkanes and polytetrafluoroethylene (PTFE).

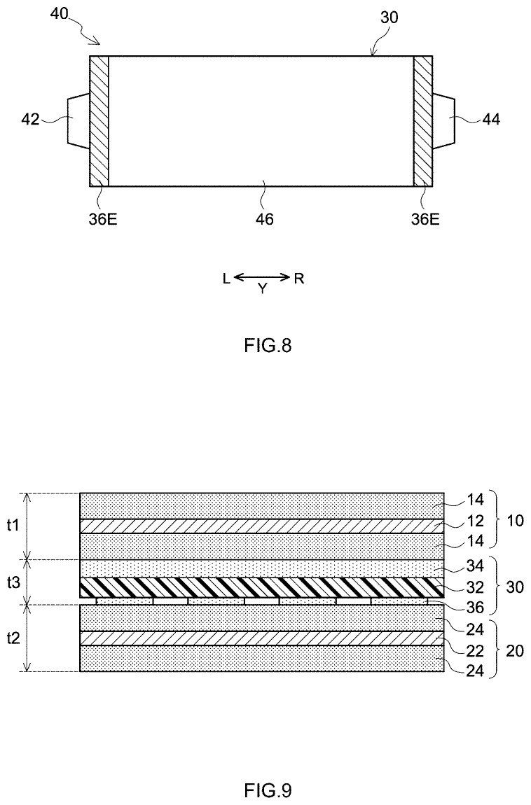

FIG. 6 is a perspective-view diagram illustrating schematically a wound electrode body 40 to which a respective positive electrode second collector 72 and a respective negative electrode second collector 77 are attached. FIG. 7 is a schematic diagram illustrating the configuration of a wound electrode body 40. FIG. 8 is a plan-view diagram illustrating schematically a wound electrode body 40. FIG. 9 is an enlarged-view diagram illustrating schematically an interface between a positive electrode plate 10, a negative electrode plate 20, and a separator 30 of the wound electrode body 40. The reference symbol MD in FIG. 7 and so forth signifies the longitudinal direction (i.e. transport direction) of the wound electrode body 40 and the separator 30 produced in a band shape, and denotes herein the machine direction. The reference symbol TD signifies a direction perpendicular to the “MD direction”, and indicates herein a “width direction (transverse direction)”. The “TD direction” is the same direction as that denoted the reference symbol Y (width direction) above.

As illustrated in FIG. 7, each electrode body used in the battery 100 is a wound electrode body 40 resulting from laying up a band-shaped positive electrode plate 10 and a band-shaped negative electrode plate 20 on each other, while insulated from each other by two band-shaped separators 30, the resulting stack being then wound, in the longitudinal direction, about a winding axis WL. Each wound electrode body 40 has herein a flat external shape. Such a flat-shaped wound electrode body 40 can be formed for instance by press molding of an electrode body wound to a cylindrical shape. Alternatively, the flat-shaped wound electrode body 40 can be formed by winding the band-shaped positive electrode plate 10, the band-shaped negative electrode plate 20, and the band-shaped separators 30 to a flat shape. As illustrated in FIG. 3, the flat-shaped wound electrode body 40 has a pair of curved portions 40r having curved outer surfaces, and a flat portion 40f having a flat outer surface and that connects the pair of curved portions 40r. As illustrated in FIG. 2, in the battery 100 the wound electrode bodies 40 are accommodated in the battery case 50 so that the winding axis WL and the width direction Y of the battery 100 substantially match each other.

A thickness T (see FIG. 5) of the wound electrode body 40 is preferably 5 mm or larger, more preferably 8 mm or larger, and is preferably 30 mm or smaller, more preferably 20 mm or smaller. An elastic action elicited by the curved portions 40r after press molding increases with increasing thickness T. As a result, springback in which the flat portion 40f expands on account of the residual elastic action of the curved portions 40r is likelier to occur. However, the art disclosed herein allows sufficiently suppressing the occurrence of springback even when the thickness T is large. The term “thickness T of the wound electrode body 40” denotes the length (average length) of the flat portion 40f in a direction perpendicular to the flat portion 40f (see FIG. 3).

A height H (see FIG. 5) of the wound electrode body 40 is preferably 120 mm or smaller, and is more preferably from 60 to 120 mm, yet more preferably from 80 to 110 mm, and particularly preferably from 90 to 100 mm. The term “height H of the wound electrode body 40” denotes the length (average length) in a direction perpendicular to the winding axis WL of the wound electrode body 40 and perpendicular to the thickness direction of the wound electrode body 40. Specifically, the height H denotes the length (average length) from an upper end of one of curved portions 40r to a lower end of the other curved portions 40r (see FIG. 3).

Preferably, the number of winding turns of the wound electrode body 40 is adjusted as appropriate taking into consideration for instance the intended performance of the battery 100 and production efficiency. The number of winding turns is preferably 20 or more, and more preferably 25 or more. When there are numerous winding turns, the elastic action after press molding becomes larger, as in the case where the thickness T is large. However, the art disclosed herein allows sufficiently suppressing the occurrence of springback even when the number of winding turns is large, as described above. A concrete configuration of the wound electrode body 40 according to the present embodiment will be explained below.

The positive electrode plate 10 is a band-shaped member, as illustrated in FIG. 7. The positive electrode plate 10 abuts a heat-resistant layer 34, as illustrated in FIG. 9. The positive electrode plate 10 includes a band-shaped positive electrode core body 12 and a positive electrode active material layer 14 applied on the positive electrode core body 12. In the present embodiment the positive electrode active material layer 14 is preferably formed on both faces of the positive electrode core body 12, from the viewpoint of battery performance. In the positive electrode plate 10, positive electrode tabs 12t protrude outward (towards the left in FIG. 7) from one edge in the width direction TD. The positive electrode tabs 12t are provided as a plurality thereof at predetermined intervals in the longitudinal direction MD. The positive electrode tabs 12t are regions at which the positive electrode active material layer 14 is not formed, and the positive electrode core body 12 is exposed. A protective layer 16 is formed as a band shape along the longitudinal direction MD of the positive electrode plate 10, in a region adjacent to an edge of the positive electrode plate 10, on the side of the positive electrode tabs 12t.

Conventionally known materials that can be used in batteries in general (for instance in lithium ion secondary batteries) can be utilized, without particular limitations, in the members that make up the positive electrode plate 10. For instance a metallic foil having a predetermined conductivity can be preferably used in the positive electrode core body 12. Preferably, the positive electrode core body 12 is for instance made up of aluminum or an aluminum alloy.

The positive electrode active material layer 14 contains a positive electrode active material and a positive electrode binder. The positive electrode active material is a particulate material capable of reversibly storing and releasing charge carriers. The positive electrode active material contains at least a lithium-transition metal complex oxide. As a result, a high-performance positive electrode plate 10 can be achieved stably, and the occurrence of springback can be suitably suppressed. A preferred example of the lithium-transition metal complex oxide is a lithium-transition metal complex oxide represented by formula LiMO₂ (wherein M is one, two or more types of transition metal element other than Li). The above M is preferably a lithium-transition metal complex oxide containing at least one from among Ni, Co and Mn, and particularly preferably is a lithium-transition metal complex oxide containing Ni. Concrete examples of lithium-transition metal complex oxide include lithium-nickel-cobalt-manganese-based complex oxides (NCMs), lithium-nickel-based complex oxides, lithium-cobalt-based complex oxides, lithium-manganese-based complex oxides, lithium-nickel-manganese-based complex oxides, lithium-nickel-cobalt-aluminum-based complex oxides (NCAs), and lithium-iron-nickel-manganese-based-based complex oxides. Preferable examples of lithium-transition metal-based complex oxides not containing Ni, Co or Mn include lithium iron phosphate-based complex oxides (LFPs).

The term “lithium-nickel-cobalt-manganese complex oxide” encompasses oxides that contain an additional element, besides a main constituent element (Li, Ni, Co, Mn and O). Examples of such additional elements include transition metal elements and main-group metal elements such as Mg, Ca, Al, Ti, V, Cr, Si, Y, Zr, Nb, Mo, Hf, Ta, W, Na, Fe, Zn or Sn. The additional element may be a metalloid element such as B, C, Si or P, or a non-metal element such as S, F, Cl, Br or I. The same applies to other lithium transition metal-based complex oxides notated as “-based complex oxides”. However, the positive electrode active material may contain a material other than a lithium-transition metal complex oxide. Preferably, the positive electrode active material adopts the form of particles having an average particle size (D₅₀ particle size) from 2 to 20 μm.

The content ratio of the positive electrode active material (for instance lithium-transition metal complex oxide) is preferably about 90 mass % or higher, and more preferably 95 mass % or higher, relative to 100 mass % as the total solids of the positive electrode active material layer 14. The occurrence of springback can be more suitably suppressed as a result.

A packing density of the positive electrode active material (for instance lithium-transition metal complex oxide) in the positive electrode active material layer 14 is preferably 2.0 g/cc or higher, more preferably 3.0 g/cc or higher, from the viewpoint of increasing battery capacity. A high-density positive electrode active material layer 14 exhibits a large elastic action after press molding. However, the art disclosed herein allows sufficiently suppressing the occurrence of springback even when the positive electrode active material layer 14 has high density, as described above. The packing density of the positive electrode active material layer 14 may be for instance 4.0 g/cc or lower.

A resin binder conventionally used as a positive electrode binder can be utilized herein as the positive electrode binder. Concrete examples include vinyl halide resins such as polyvinylidene fluoride (PVdF), and polyalkylene oxides such as polyethylene oxide (PEO).

Preferred among the foregoing are fluorine-based binders containing fluorine, and particularly preferably PVdF, on account of its high flexibility. The mass ratio of PVdF relative to the total mass of the positive electrode binder is preferably 50 mass % or higher, more preferably 80 mass % or higher, and yet more preferably 90 mass % or higher. The positive binder may be made up of PVdF.

The positive electrode active material layer 14 may contain arbitrary components such as a conductive material and/or dispersant, besides the positive electrode active material and the positive electrode binder. Examples of conductive materials include carbon black, typically activated carbon such as acetylene black (AB) and Ketjen black, as well as carbon materials such as graphite and carbon fibers.

The porosity of the positive electrode active material layer 14 is preferably from 10 to 30 vol %. The surface roughness Ra of the positive electrode active material layer 14 is preferably from 0.2 to 1.5 μm. The term “surface roughness” denotes arithmetic mean roughness (likewise hereafter).

A width w1 (see FIG. 7) of the positive electrode active material layer 14 is 100 mm or larger, preferably 200 mm or larger. A greater width w1 of the positive electrode active material layer 14 entails a greater size of the wound electrode body 40, and as a result entails a greater elastic action after press molding. However, the art disclosed herein allows sufficiently suppressing the occurrence of springback even when the width w1 is large, as described above. The width w1 may be about 400 mm or smaller, for instance 350 mm or smaller. The term “width w1 of the positive electrode active material layer 14” denotes the length (average length) of the positive electrode active material layer 14 in the width direction TD that is perpendicular to the longitudinal direction of the wound electrode body 40. A ratio (w1/H) of the length w1 of the positive electrode active material layer 14 in the width direction relative to the height H of the wound electrode body 40 is preferably 2 or higher, and more preferably 2.5 or higher.

An overall thickness t1 (see FIG. 9) of the positive electrode plate 10 is preferably 80 μm or larger, more preferably 100 μm or larger, and yet more preferably 120 μm or larger. A greater overall thickness t1 entails a greater elastic action after press molding, similarly to the above case where the width w1 is large. However, the art disclosed herein allows sufficiently suppressing the occurrence of springback even when the overall thickness t1 of the positive electrode plate 10 is large. The overall thickness t1 is preferably 200 μm or smaller, more preferably 180 μm or smaller, and yet more preferably 160 μm or smaller. The term “overall thickness of the positive electrode plate 10” denotes the total of the thickness (average thickness) of the positive electrode core body 12 and of the positive electrode active material layer 14 in the region where the positive electrode active material layer 14 is formed.

The protective layer 16 is a layer configured to have lower electrical conductivity than that of the positive electrode active material layer 14. The protective layer 16 is provided in a region adjacent to an edge of the positive electrode plate 10. As a result, it becomes possible to prevent internal short circuits caused by direct contact between the positive electrode core body 12 and the negative electrode active material layer 24 when the separator 30 is damaged. Preferably, the protective layer 16 contains insulating ceramic particles. Examples of ceramic particles include inorganic oxides such as alumina (Al₂O₃), magnesia (MgO), silica (SiO₂) and titania (TiO₂); nitrides such as aluminum nitride and silicon nitride; metal hydroxides such as calcium hydroxide, magnesium hydroxide and aluminum hydroxide; clay minerals such as mica, talc, boehmite, zeolite, apatite and kaolin; and glass fibers. Alumina, boehmite, aluminum hydroxide, silica and titania are preferred most especially. The protective layer 16 may contain a binder for fixing the ceramic particles on the surface of the positive electrode core body 12. Examples of such a binder include resin binders such as polyvinylidene fluoride (PVdF). However, the protective layer is not an essential constituent element of the positive electrode plate 10. Specifically, in other embodiments there may be used a positive electrode plate having no protective layer 16 formed thereon.

The negative electrode plate 20 is a band-shaped member, as illustrated in FIG. 7. The negative electrode plate 20 abuts an adhesive layer 36, as illustrated in FIG. 9. The negative electrode plate 20 is bonded to the separator 30. The negative electrode plate 20 includes a band-shaped negative electrode core body 22 and a negative electrode active material layer 24 applied on the negative electrode core body 22. Preferably, the negative electrode active material layer 24 is formed on both faces of the negative electrode core body 22, in terms of battery performance. In the negative electrode plate 20, negative electrode tabs 22t protrude outward (towards the right in FIG. 7) from one edge in the width direction TD. The negative electrode tabs 22t are provided as a plurality thereof at predetermined intervals in the longitudinal direction MD. The negative electrode tabs 22t are regions at which the negative electrode active material layer 24 is not formed, and the negative electrode core body 22 is exposed.

Conventionally known materials that can be used in batteries in general (for instance in lithium ion secondary batteries) can be utilized herein, without particular limitations, in the members that make up the negative electrode plate 20. For instance a metallic foil having a predetermined conductivity can be preferably used in the negative electrode core body 22. Preferably, the negative electrode core body 22 is for instance made up of copper or a copper alloy.

The negative electrode active material layer 24 contains a negative electrode active material. The negative electrode active material is a particulate material that is capable of reversibly storing and releasing charge carriers, in a relationship with the positive electrode active material described above. The negative electrode active material contains at least graphite. However, the negative electrode active material may contain materials other than graphite. Concrete examples of negative electrode active materials other than graphite include carbon materials such as hard carbon, soft carbon and amorphous carbon, as well as silicon-based materials. Preferably, the negative electrode active material adopts the form of particles having an average particle size (D₅₀ particle size) from 3 to 25 μm.

The content ratio of the negative electrode active material (for instance graphite) is preferably 50 mass % or higher, more preferably 70 mass % or higher, and yet more preferably 80 mass % or higher, relative to 100 mass % as the total solids of the negative electrode active material layer 24. A negative electrode active material layer 24 containing a large amount of the negative electrode active material elicits a large elastic action after press molding. However, the art disclosed herein allows sufficiently suppressing the occurrence of springback even when the negative electrode active material has high density, as described above. Preferably, the packing density of the negative electrode active material (for instance graphite) in the negative electrode active material layer 24 is from 1.4 to 1.9 g/cm³.

The negative electrode active material layer 24 may contain for instance arbitrary components such as negative electrode binders and a conductive material, besides the negative electrode active material. Carbon materials such as those exemplified as optional components that the positive electrode active material layer 14 can contain may be used herein as the conductive material. Examples of negative electrode binders include rubbers such as styrene-butadiene rubber (SBR), celluloses such as carboxymethyl cellulose (CMC), acrylic resins such as polyacrylic acid (PAA), and vinyl halide resins such as polyvinylidene fluoride (PVdF). Particularly preferably, SBR and CMC are concomitantly used among the foregoing. The total mass of SBR plus the mass of CMC relative to the total mass of the negative electrode binder is preferably 50 mass % or higher, more preferably 60 mass % or higher, and yet more preferably 80 mass % or higher. The negative electrode binder may be made up of SBR and CMC.

The total mass of SBR mass plus CMC mass is more preferably 1 mass % or higher, relative to 100 mass % as the total solids of the negative electrode active material layer 24. Studies by the inventors have revealed that the occurrence of springback may be affected also by the addition amount of SBR and CMC. By satisfying the above content ratio the effect of the art disclosed herein can be brought out at a high level.

The porosity of the negative electrode active material layer 24 is preferably from 20 to 40 vol %. The surface roughness Ra of the negative electrode active material layer 24 is preferably 0.05 μm or larger, and more preferably 0.4 μm or larger. When the surface of the negative electrode active material layer 24 has fine irregularities, the adhesive layer 36 of the separator 30 bites into the surface of the negative electrode active material layer 24 on account of an anchor effect, and the separator 30 and the negative electrode plate 20 are readily bonded to each other. The surface roughness Ra of the negative electrode active material layer 24 may be about 5 μm or smaller, for instance 1.8 μm or smaller.

A width w2 (see FIG. 7) of the negative electrode active material layer 24 is preferably from 20 to 45 cm, more preferably from 25 to 35 cm, in a relationship with the width w1 of the positive electrode active material layer 14 described above. The negative electrode active material layer 24 covers the positive electrode active material layer 14 at both ends in the width direction Y.

An overall thickness t2 (see FIG. 9) of the negative electrode plate 20 is preferably 100 μm or larger, more preferably 130 μm or larger, and yet more preferably 160 μm or larger. Similarly to the case of the positive electrode plate 10 described above, the elastic action after press molding increases when the overall thickness t2 increases. However, the art disclosed herein allows sufficiently suppressing the occurrence of springback even when the overall thickness t2 of the negative electrode plate 20 is large. The overall thickness t2 is preferably 250 μm or smaller, more preferably 220 μm or smaller, and yet more preferably 190 μm or smaller. The “overall thickness of the negative electrode plate 20” denotes the total of the thickness (average thickness) of the negative electrode core body 22 and the negative electrode active material layer 24 in the region where the negative electrode active material layer 24 is formed.

Each separator 30 is a band-shaped member, as illustrated in FIG. 7. Two separators 30 are used in one wound electrode body 40. Each separator 30 is an insulating sheet having formed therein a plurality of fine through-holes through which charge carriers can pass. Through interposition of the separators 30 between the positive electrode plate 10 and the negative electrode plate 20 it becomes possible to prevent contact between the positive electrode plate 10 and the negative electrode plate 20, and movement of charge carriers (for instance lithium ions) between the positive electrode plate 10 and the negative electrode plate 20.

Each separator 30 includes a band-shaped base material layer 32, the heat-resistant layer 34 formed on one surface of the base material layer 32, and the adhesive layer 36 formed on the other surface of the base material layer 32. As illustrated in FIG. 9, the heat-resistant layer 34 opposes the positive electrode plate 10. As a result, heat shrinkage of the separator 30 at high temperatures can be suppressed, and for instance the gas generated inside the wound electrode body 40, during initial charging or during overcharging of the battery 100, can be discharged smoothly out of the wound electrode body 40. The adhesive layer 36 opposes the negative electrode plate 20. As a result, expansion of the flat portion 40f of the wound electrode body 40 in the thickness direction after press molding is curtailed, and the occurrence of springback is suppressed.

Preferably, the adhesive layer 36 does not oppose the positive electrode plate 10. Studies by the inventors have revealed that when the adhesive layer 36 opposes the positive electrode plate 10, the positive electrode plate 10 and the separator 30 become firmly bonded to each other in a press molding step. As a result, it may become difficult for the electrolyte solution to permeate into the wound electrode body 40. The positive electrode plate 10 and the separator 30 are not readily bonded to each other, and the permeability of the electrolyte solution can be improved, by prescribing the adhesive layer 36 not to oppose the positive electrode plate 10. Battery characteristics (for instance at least one from among cycle characteristics, storage characteristics and durability) can be improved as a result.

Base material layers used in conventionally known battery separators can be used herein, without particular limitations, as the base material layer 32. The base material layer 32 is preferably a porous sheet-shaped member. The base material layer 32 may have a single-layer structure, or may have a structure of two or more layers, for instance a three-layer structure. Preferably, the base material layer 32 is made up of a polyolefin resin. As a result, the flexibility of the separators 30 can be sufficiently ensured, and the wound electrode bodies 40 can be easily achieved (wound and press molded). The polyolefin resin is preferably made up of polyethylene (PE), polypropylene (PP) or a mixture thereof, and is more preferably made up of PE. The thickness of the base material layer 32 is preferably from 3 to 25 μm, more preferably from 3 to 18 μm, and yet more preferably from 5 to 14 μm. The air permeability of the base material layer 32 is preferably from 30 to 500 sec/100 cc, more preferably from 30 to 300 sec/100 cc, and yet more preferably from 50 to 200 sec/100 cc.

The heat-resistant layer 34 abuts the positive electrode plate 10 (typically the positive electrode active material layer 14). The heat-resistant layer 34 may be directly provided on the surface of the base material layer 32, or may be provided on the base material layer 32 via another layer. By providing the heat-resistant layer 34 it becomes possible to suppress heat shrinkage of the separator 30 and improve the safety of the battery 100. The heat-resistant layer 34 contains ceramic particles and a heat-resistant layer binder.

Inorganic materials such as those exemplified as materials that the protective layer 16 can contain may be used herein as the ceramic particles. Preferred among the foregoing are alumina, zirconia, boehmite, aluminum hydroxide, silica and titania, for instance in terms of insulating properties, heat resistance and availability; in particular, the ceramic particles are preferably of a compound that contains aluminum, from the viewpoint of suppressing heat shrinkage in the separators 30. The mass ratio of the ceramic particles relative to the total mass of the heat-resistant layer 34 is preferably 90 mass % or higher, and more preferably 95 mass % or higher.

Conventionally known resins having a certain viscosity towards the positive electrode plate 10 may be used, without particular limitations, as the heat-resistant layer binder there may be used. Concrete examples include acrylic resins, fluororesins, urethane resins, ethylene vinyl acetate resins and epoxy resins. Acrylic resins are preferred among the foregoing. In the present embodiment, preferably, at least one from among the positive electrode binder contained in the positive electrode active material layer 14 and the heat-resistant layer binder contained in the heat-resistant layer 34 contains no fluorine-based binder. In other words, in the present embodiment only one from among the positive electrode binder and the heat-resistant layer binder may contain a fluorine-based binder. In the present specification, the term “fluorine-based binder” denotes binders in general containing fluorine (F) as a constituent element, while the term “non-fluorine-based binder” denotes binders in general that do not contain fluorine (F) as a constituent element.

As an example, in a case where the positive electrode binder is made up of a non-fluorine-based binder, the heat-resistant layer binder may be a fluorine-based binder or a non-fluorine-based binder. The type of the heat-resistant layer binder may be the same as that of the positive electrode binder. As another example, in a case where the positive electrode binder contains a fluorine-based binder (for instance PVdF), the heat-resistant layer binder preferably contains no fluorine-based binder (for instance PVdF). In other words, the heat-resistant layer binder is preferably made up of a non-fluorine-based binder. Findings by the inventors have revealed that in a case where the positive electrode binder and the heat-resistant layer binder both contain a fluorine-based binder, compatibility (affinity) between the foregoing is excessively high, and the separators 30 may become firmly attached to the positive electrode plate 10. It may be therefore difficult for the electrolyte solution to permeate into the wound electrode body 40. By configuring at least one from among the positive electrode binder and the heat-resistant layer binder out of a non-fluorine-based binder, the positive electrode plate 10 and the separator 30 bond to each other less readily, and the permeability of the electrolyte solution can be further improved.

Preferably, the content ratio of the ceramic particles is from 60 to 85 mass %, relative to 100 mass % as the total solids of the heat-resistant layer 34. In the heat-resistant layer 34 the mixing ratio (mass ratio) of the ceramic particles and the heat-resistant layer binder lies preferably in the range from 98:2 to 50:50, and more preferably from 95:5 to 70:30. Heat shrinkage of the base material layer 32 is suppressed by prescribing the content of the inorganic particles to be not smaller than a predetermined amount. The thickness of the heat-resistant layer 34 is preferably from 0.3 to 6 μm, more preferably from 0.5 to 6 μm, and yet more preferably from 1 to 4 μm. The surface roughness Ra of the heat-resistant layer 34 is preferably from 0.2 to 1.0 μm.

Preferably, the basis weight of the heat-resistant layer 34 is relatively larger at end portions than at a central portion in the width direction TD of the separator 30. As a result, the separator 30 can be suitably prevented from shrinking from the end portions in the width direction Y towards the center, in a drying step of the wound electrode body 40.

The adhesive layer 36 abuts the negative electrode plate 20 (typically the negative electrode active material layer 24). The adhesive layer 36 is bonded to the negative electrode plate 20 (typically the negative electrode active material layer 24) by press molding. The adhesive layer 36 is provided on the surface of the base material layer 32, on the reverse side from that of the heat-resistant layer 34. The adhesive layer 36 may be directly provided on the surface of the base material layer 32, or may be provided on the base material layer 32 via another layer. The occurrence of springback caused by the negative electrode plate 20 can be suppressed by providing the adhesive layer 36. The adhesive layer 36 contains the adhesive layer binder. The adhesive layer 36 may further contain other materials (for instance inorganic particles such as ceramic particles).

Conventionally known resins having a certain viscosity towards the negative electrode plate 20 can be used herein, without particular limitations, as the adhesive layer binder. Concrete examples include resins such as fluororesins, acrylic resins, urethane resins, ethylene vinyl acetate resins and epoxy resins. Examples of fluororesins include polyvinylidene fluoride (PVdF) and polytetrafluoroethylene (PTFE). Fluororesins and acrylic resins are preferred among the foregoing, since these have high flexibility and allow bringing out more suitably adhesiveness towards the negative electrode plate 20. The adhesive layer binder may be identical to or different from the heat-resistant layer binder. The adhesive layer binder may contain a plurality of resin particles. The resin particles may melt partly or wholly for instance under the influence of press molding, and the shape of the particles need not be preserved in the interior of the battery 100.

The mass ratio of the heat-resistant layer binder in the adhesive layer 36 relative to the total mass of the adhesive layer is 15 mass % or higher. As a result, predetermined adhesiveness towards the negative electrode plate 20 is accurately brought out, and the separator 30 deforms readily during press molding. The effect of the art disclosed herein can be realized as a result at a higher level. The content of the heat-resistant layer binder is more preferably 20 mass % or higher, and yet more preferably 25 mass % or higher. The thickness of the adhesive layer 36 is preferably from 0.3 to 6 μm, more preferably from 0.5 to 6 μm, and yet more preferably from 1 to 4 μm.

The adhesive layer 36 can be formed, in a plan view, in a dotted shape, a striped shape, a wavy shape, a band shape (streak shape), a dashed line shape or a combination of the foregoing. In a plan view, a ratio of a formation surface area of the adhesive layer 36 relative to the entire surface area of the base material layer 32 is preferably 0.3 or higher, more preferably 0.5 or higher, and yet more preferably 0.6 or higher. Adhesiveness with the negative electrode plate 20 can be improved thereby. The effect of the art disclosed herein can be realized as a result at a higher level.

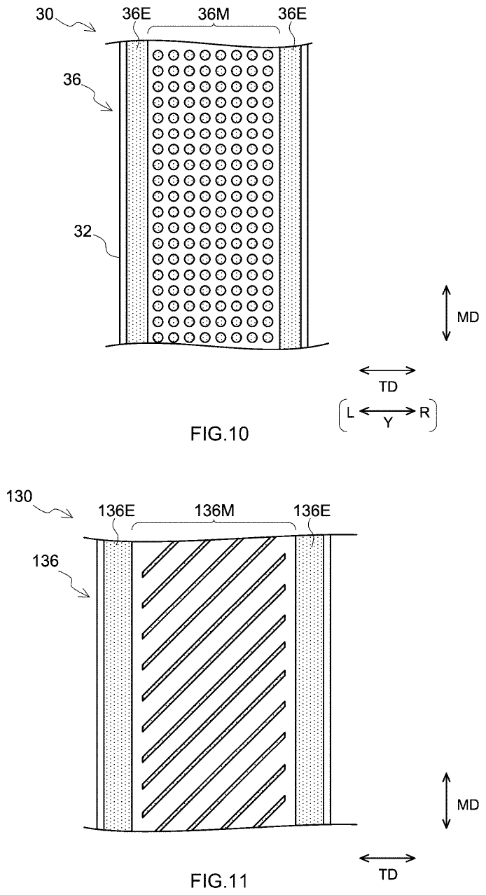

FIG. 10 is a plan-view diagram illustrating the surface of the separator 30 prior to bonding to the negative electrode plate 20. In the present embodiment the adhesive layer 36 has two band-shaped first regions 36E and a dotted second region 36M. The two band-shaped first regions 36E are provided at a pair of end portions of each separator 30 in the width direction TD. The two first regions 36E extend along the longitudinal direction MD of the separator 30. As illustrated in FIG. 8, the first regions 36E are provided so as to cover both ends of the wound electrode body 40 in the width direction Y. The first regions 36E are preferably provided over a width so as to cover both ends of a reaction portion 46 in the width direction Y (i.e. both ends of the negative electrode active material layer 24 in the width direction). Studies by the inventors have revealed that in a case where the front and back of the separator 30 are configured differently, as in the present embodiment, the separator 30 shrinks locally in the drying step of the wound electrode body 40, thereby giving rise to wrinkles and Z-shaped folds. By providing the band-shaped first regions 36E at the end portions of the separator 30 it becomes possible to suppress shrinkage of the separator 30 during the drying step, and to thereby suppress for instance wrinkles in the wound electrode body 40. Moreover, inter-electrode distance does not readily increase locally in the vicinity of the electrode tab group, and precipitation of charge carriers (Li) can be suppressed. Wrinkles and folds in the separator 30 can be suppressed also in a case the first regions 36E are stripe-shaped, as in the above case where the first regions 36E are band-shaped.

The dotted second region 36M is provided between both end portions in the width direction Y. The second region 36M is provided so as to overlap at least part of the reaction portion 46 (see FIG. 8) of the wound electrode body 40. The permeability of the electrolyte solution into the wound electrode body 40 can be improved thus by forming the second region 36M to a dotted shape. The dots that make up the second region 36M are circular and all are herein of substantially identical size. However, in other embodiments the shape of the dots may be polygonal, or the circle diameters may be mutually dissimilar. The size of the dots that make up the second region 36M is preferably from 0.35 to 1.6 mm, and more preferably from 0.5 to 1.0 mm. The size of the dots denotes herein the diameter of the dots. In the second region 36M the dots are disposed at equal intervals. The spacing between the dots is preferably 1.5 mm or larger, and more preferably ranges from 1.7 to 2 mm.

The basis weight of the adhesive layer 36 (first regions 36E and/or second region 36M) is preferably from 0.005 to 2.0 g/m², more preferably from 0.005 to 1.0 g/m² and yet more preferably from 0.02 to 0.04 g/m². Preferably, the first regions 36E positioned at the end portions in the width direction Y have a relatively higher basis weight than that of the second region 36M positioned between the first regions 36E in the width direction Y. As a result, the separators 30 can be suitably prevented from shrinking from the end portions in the width direction Y towards the center, in the drying step of the wound electrode body 40.

A width w3 (see FIG. 7) of each separator 30 is longer than the width w2 of the negative electrode active material layer 24. The separator 30 covers the negative electrode active material layer 24 at both ends in the width direction Y. The width w1 of the positive electrode active material layer 14, the width w2 of the negative electrode active material layer 24, and the width w3 of the separator satisfy a relationship w1<w2<w3. The width w3 of the separator 30 is substantially identical to the width of the wound electrode body 40. Therefore, the width of the wound electrode body 40 can be roughly determined by the width w1 of the positive electrode active material layer 14.

An overall thickness t3 (see FIG. 9) of the separator 30 is preferably 4 μm or larger, more preferably 8 μm or larger, and yet more preferably 12 μm or larger. The overall thickness t3 is preferably 28 μm or smaller, more preferably 24 μm or smaller, and yet more preferably 20 μm or smaller. The term “overall thickness t3 of the separator 30” denotes the total of the thickness (average thickness) of the base material layer 32, the heat-resistant layer 34 and the adhesive layer 36. The adhesive layer 36 may have a three-dimensional network structure that includes a plurality of voids. In that case the thickness may be smaller than the overall thickness t3 at portions squashed for instance by press molding. However, variability in the thickness of the wound electrode body 40 can be absorbed as a result by the separator 30, and a wound electrode body 40 of uniform thickness can thus be produced.

2. Battery Production Method

The battery 100 can be produced in accordance with a production method that includes an electrode body production step of laying up the positive electrode plate 10 and the negative electrode plate 20 with the separator 30 interposed in between, to thereby produce the wound electrode body 40. Otherwise, the production process may be identical to conventional processes. In addition, the production method disclosed herein may further include other steps, at any stage. The electrode body production step includes: (1) a winding process, and (2) a press molding step, in this order. The production process may further include also (3) a drying step after the winding step (1) or the press molding step (2).

In the winding step (1) there is produced a cylindrical wound body (cylindrical body) that is provided with the band-shaped positive electrode plate 10, the band-shaped negative electrode plate 20 and the band-shaped separators 30. Specifically, a winding device provided with a winding unit is prepared first. Next, the positive electrode plate 10, the negative electrode plate 20, and the separators 30 are each wound into a respective reel that is set in the winding device. Next, the tips of the two separators 30 are fixed to a winding core of the winding unit. That is, the two separators 30 are nipped by the winding core. The band-shaped positive electrode plate 10 and the band-shaped negative electrode plate 20 are next laid up on each other across two separators 30 interposed in between. At this time, the heat-resistant layer 34-side of the separator 30 is set to oppose the positive electrode plate 10, and the adhesive layer 36-side is set to oppose the negative electrode plate 20. The winding core is caused to rotate while the band-shaped positive electrode plate 10 and the band-shaped negative electrode plate 20 are supplied, to thereby wind the positive electrode plate 10, the negative electrode plate 20, and the separators 30. Once winding is over, a winding stop tape (not shown) is attached to a termination portion of each separator 30. A cylindrical body is produced thus as described above.

In the press molding step (2), the wound cylindrical body is press-molded to a flat shape, as illustrated in FIG. 7. Preferably, the press molding condition (for instance pressure, holding time and so forth) are regulated as appropriate for instance in accordance with the flexibility of the adhesive layer 36 and the number of winding turns. Press molding may be performed at room temperature, or may be performed while under heating (at a high temperature). As a result of press molding, the positive electrode tab group 42 in which the positive electrode tabs 12t are stacked becomes formed at one end portion in the width direction Y of the wound electrode body 40, while the negative electrode tab group 44 in which the negative electrode tabs 22t are stacked becomes formed at the other end portion. The reaction portion 46 in which the positive electrode active material layer 14 and the negative electrode active material layer 24 oppose each other becomes formed in the central portion of the wound electrode body 40 in the width direction Y. The wound electrode body 40 having the positive electrode plate 10, the negative electrode plate 20 and the separators 30 is thus produced as described above.

In the present embodiment the adhesive layer 36 of the separator 30 is bonded to the negative electrode plate 20 by press molding. Specifically, when the cylindrical body is squashed at the time of press molding a large pressure is applied to the positive electrode plate 10, the negative electrode plate 20 and the separators 30 positioned at the flat portion 40f. An anchor effect is elicited herein as a result of squashing of the adhesive layer binder contained in the adhesive layer 36. Alternatively, the adhesive layer binder breaks apart while being squashed. As a result, the adhesive layer 36 is deformed, by being pressed, while conforming to the relief on the surface of the negative electrode active material layer 24. The separator 30 and the negative electrode plate 20 are bonded (pressure-bonded) to each other as a result.

The adhesive strength between each separator 30 and the negative electrode plate 20, more specifically, the adhesive strength between the adhesive layer 36 and the negative electrode active material layer 24 is preferably 0.5 N/m or larger, more preferably 0.75 N/m or larger, and yet more preferably 1.0 N/m or larger. The occurrence of springback can be suppressed more suitably as a result. The term “adhesive strength” in the present specification denotes 90° peel strength according to JIS Z0237.

In the drying step (3) water contained in the wound electrode body 40 is removed. For instance air drying, heat drying or vacuum drying can be resorted to as the drying method. When heat drying is resorted to, as an example, the heating temperature is preferably 120° C. or lower, from the viewpoint of suppressing heat shrinkage of the separators 30 (in particular heat shrinkage of the base material layer 32).

The battery 100 can be used for various applications, and can be suitably used for instance as a power source (drive power source) for motors mounted on vehicles such as passenger cars and trucks. The type of vehicle is not particularly limited, and examples thereof include plug-in hybrid automobiles (PHEVs; Plug-in Hybrid Electric Vehicles), hybrid automobiles (HEVs; Hybrid Electric Vehicles) and electric cars (BEVs; Battery Electric Vehicles). Battery reaction variability is suppressed in the battery 100, and hence the battery 100 can be suitably used for constructing an assembled battery.

Several embodiments relating to the present disclosure will be explained below, but the disclosure is not meant to be limited to these embodiments.

Production of a Cylindrical Wound Body (Cylindrical Body)

As Example 1, firstly a separator was prepared that had a base material layer, a heat-resistant layer formed on one surface of the base material layer, and an adhesive layer formed on the other surface of the base material layer, such as those below. The heat-resistant layer and the adhesive layer are formed on the entire surface of the base material layer.
Separator of Example 1
   Base material layer (material: polyolefin resin (PE), thickness: 14 μm, air permeability: 180 sec/cc)
   Heat-resistant layer (components: ceramic particles+acrylic binder (content of ceramic particles: 90 mass % or higher), thickness: 2 μm, basis weight: 8.0 g/cm²)
   Adhesive layer (component: acrylic resin, thickness: 2 μm, basis weight: 4.0 g/cm²)

As comparative examples there were further prepared a separator that had a heat-resistant layer formed on both faces of a base material layer, a separator having an adhesive layer formed on both faces of the base material layer, and a separator having only a base material layer. Cylindrical wound bodies (Example 1, Comparative examples 1 to 4) given in Table 1 were produced by performing a winding step such as that described above, using the above separators. The positive electrode plate that was used had a positive electrode active material layer containing a lithium-transition metal complex oxide as a positive electrode active material, PVdF as a positive electrode binder, and a carbon material, as a conductive material, on an aluminum foil. The negative electrode plate that was used had a negative electrode active material layer containing graphite as a negative electrode active material, SBR and CMC as negative electrode binders, and a carbon material as a conductive material, on a copper foil. In Example 1 each separator was disposed so that the heat-resistant layer opposed the positive electrode plate and the adhesive layer opposed the negative electrode plate. In Comparative example 3, the arrangement of each separator was flipped with respect to that in Example 1.

TABLE 1

| | Surface configuration of separator | | Height:width | Evaluation results | |
|---|---|---|---|---|---|
| | Positive | Negative | ratio of wound | Springback | Gas |
| | electrode side | electrode side | electrode body | rate | entrainment |
| Example 1 | Heat-resistant | Adhesive layer | 1:3 | 10% | No |
| | layer | | | | |
| Comp. ex. | Heat-resistant | Heat-resistant | 1:3 | 75% | No |
| 1 | layer | layer | | | |
| Comp. ex. | Adhesive layer | Adhesive layer | 1:3 | 8% | Yes x |
| 2 | | | | | |
| Comp. ex. | Adhesive layer | Heat-resistant | 1:3 | 35% | No |
| 3 | | layer | | | |
| Comp. ex. | Base material | Base material | 1:3 | 45% | No |
| 4 | | | | | |

Measurement of Springback Rate

A springback rate was measured next while the press molding step was carried out according to the procedures below.
(Procedure 1) Each cylindrical wound body produced above was squashed to a flat shape through press molding at a pressure of 0.4 kN/cm².
(Procedure 2) The thickness of the wound electrode body immediately after press molding (immediately-subsequent thickness) was measured.
(Procedure 3) The wound electrode body was allowed to stand for 1 hour at normal temperature.
(Procedure 4) The thickness of the wound electrode body after 1 hour had elapsed (thickness after 1 hour) was measured.
(Procedure 5) An amount of springback (%) was calculated on the basis of the following expression: (immediately−subsequent thickness/thickness after 1 hour)×100. The results are given in Table 1.

Evaluation of Gas Entrainment

A lithium ion secondary battery was constructed next using the flat-shaped wound electrode body produced above, and the gas releasability of the wound electrode body was evaluated while initial charging and discharge of the battery was carried out according to the procedure below.
(Procedure 1) The battery was charged at 25° C., at a charging rate of 1/2C for 45 minutes.
(Procedure 2) The charged battery was placed in a thermostatic bath at 60° C. and was allowed to stand for 12 hours.
(Procedure 3) The temperature of the thermostatic bath was lowered down to 25° C., after which the battery was discharged at a discharge rate of 1/2C for 30 minutes.
(Procedure 4) The battery was disassembled in an argon atmosphere, the wound electrode body was taken apart, and it was checked whether bubbles were present in the interior of the wound electrode body. The results are given in Table 1.

As Table 1 reveals, the springback rate was relatively large in Comparative examples 1, 3 and 4. In Comparative example 2, moreover there was no place for the gas to escape during initial charging and discharge, and gas entrainment was observed to occur. In contrast to these comparative examples, in Example 1 the occurrences of both springback and gas entrainment during initial charging and discharge were suppressed. These results bear out the significance of the art disclosed herein.

Several embodiments of the present disclosure have been explained above, but these embodiments are merely illustrative in character. The present disclosure can be implemented in various other forms. The present disclosure can be implemented on the basis of the disclosure of the present specification and common technical knowledge in the relevant field. The art set forth in the claims encompasses various modifications and alterations of the embodiments illustrated above. For instance, other embodiment variations may substitute for part of the embodiments described above, or alternatively other embodiment variations may be added to embodiments described above. Moreover, a given feature may be expunged as appropriate if the feature is not explained as essential.

For instance, the battery case 50 in the embodiments described above accommodates three wound electrode bodies 40. However, the number of electrode bodies accommodated in one battery case is not particularly limited, and the accommodated electrode bodies may be two or more (plurality), or just one.

For instance in the embodiment described above the adhesive layer 36 of the separator 30 had the band-shaped first regions 36E and the dotted second region 36M, as illustrated in FIG. 10. However, the adhesive layer 36 is not limited thereto. For instance the first regions 36E and/or the second region 36M may be formed to other shapes, for example to a striped shape, a wavy shape, a band shape. A uniform adhesive layer 36 may be provided on the entire surface of the separator 30, without separation between the first regions 36E and the second region 36M. In some embodiments the adhesive layer 36 can also adopt shapes as in the first through fourth variations below.

First Variation

FIG. 11 is a plan-view diagram illustrating schematically a separator 130 according to a first variation. The separator 130 is similar to the above-described separator 30, except than herein the separator 130 has strip-like first regions 136E and a second region 136M formed in the shape of stripes (streaks), on the surface opposing the negative electrode plate 20. In the width direction TD, the first regions 136E are disposed at both end portions, and the second region 136M is disposed between the two first regions 136E (central portion). The first regions 136E may be similar to the first regions 36E of the separator 30 described above.

Preferably, the stripes of the second region 136M do not come into contact with the first regions 136E. In the second region 136M, the width of the lines that make up the stripes is preferably from 0.1 to 2.0 mm, more preferably from 0.3 to 1.6 mm. The spacing between the lines that make up the stripes is preferably from 1 to 25 mm, more preferably from 4 to 20 mm. The stripes extend in the width direction TD of the separator 130. Preferably, the stripes are slanted with respect to the longitudinal direction MD of the separator 130. Preferably, the inclination angle of the stripes with respect to the longitudinal direction MD lies in the range of 0±15°, which satisfies tan 0=(height H of wound electrode body 40/width w1 of positive electrode active material layer 14). The inclination angle of the stripes is preferably from 0 to 45°, and more preferably 10 to 40°. Such a configuration elicits substantially the same effect as that of the separator 30 described above.

Second Variation

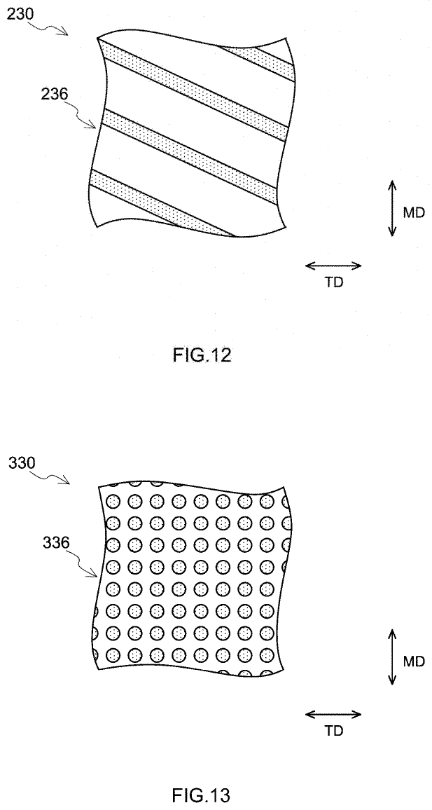

FIG. 12 is a plan-view diagram illustrating schematically a separator 230 according to a second variation. The separator 230 may be identical to the separator 130 described above, but herein the separator 230 has an adhesive layer 236 formed to a striped shape on the entire surface opposing the negative electrode plate 20. The width, spacing and inclination angle of the lines that make up the stripes in the adhesive layer 236 may be identical to those in the second region 136M of the separator 130. Preferably, the spacing between the lines that make up the stripes is 0.6 mm or smaller, from the viewpoint of suppressing wrinkling and folding of the separator 230 described above. By forming thus the striped adhesive layer 236 on the entire surface of the separator 230, the electrolyte solution can flow smoothly through non-bonded portions, and permeability of the electrolyte solution into the central portion of the wound electrode body 40 in the width direction TD can be improved. Moreover, battery performance (for instance rapid charge/discharge characteristics) can be improved since liquid flows in the interior of the wound electrode body 40 on account of gravity, even in the absence of capillary action.

In the second variation, the lines that make up the stripes are straight lines, but in other implementations the lines may be for instance wavy or dashed, and each line may be made up of an aggregate of a plurality of dots. When for instance the lines that make up the stripes are wavy, the bonding area can be made larger than in a case where the lines are straight lines. It becomes therefore possible to promote impregnation of the electrolyte solution while ensuring adhesive strength, and to enhance the permeability of the electrolyte solution into the central portion of the wound electrode body 40 in the width direction TD.

Third Variation

FIG. 13 is a plan-view diagram illustrating schematically a separator 330 according to a third variation. The separator 330 may be identical to the separator 30 described above, except that herein the separator 330 has an adhesive layer 336 formed to a dotted shape on the entire surface on the side opposing the negative electrode plate 20. The diameter and spacing of the dots that make up the adhesive layer 336 may be identical to those of the second region 36M of the separator 30. Preferably, the spacing between the dots that make up the stripes is 0.6 mm or smaller, from the viewpoint of suppressing wrinkling and folding of the separator 330 described above. By forming thus the dotted adhesive layer 336 on the entire surface of the separator 330 it becomes possible to ease the surface pressure distribution, and to achieve uniform bonding in the press molding step. If capillary phenomena are exploited, moreover, impregnation of the electrolyte solution into multiple directions can be promoted, and permeability of the electrolyte solution into the central portion of the wound electrode body 40 in the width direction TD can be enhanced. It is moreover possible to realize better gas releasability, and to suppress the occurrence of gas entrainment at a high level.

In the third variation all the dots that make up the adhesive layer 336 have substantially the same size. In other embodiments, however, the sizes of the dots that make up the adhesive layer 336 may be mutually different. For instance the adhesive layer 336 may have a first dot region and two second dot regions made up of dots of smaller size than that of the first dot region. A configuration may also be adopted in which the two second dot regions are disposed at both end portions in the width direction TD, and the first dot region is disposed between the two second dot regions (central portion), so that the central portion has a greater bonding area with the negative electrode plate 20. Furthermore, a third dot region made up of dots having a size intermediate to that of the first dot region and the second dot regions may be formed between the first dot region and the second dot regions. As a result, the size of the dots decreases stepwise (or gradually) from the central portion towards the end portions, in the width direction TD, and the bonding area with the negative electrode plate 20 decreases likewise. The size of the dots that make up the first dot region is preferably from 0.05 to 20 mm, more preferably from 0.05 to 10 mm, and yet more preferably from 0.2 to 2.0 mm. The size of the dots that make up the second dot regions is preferably from 0.01 to 20 mm, more preferably from 0.01 to 10 mm, and yet more preferably 0.1 to 2.0 mm. Liquid flow in the wound electrode body 40 can be promoted by setting dissimilar bonding areas between the end portions and the central portion in the width direction TD, to thereby impart a gradient to the degree of bonding to the negative electrode plate 20. As a result it becomes possible to increase the permeability of the electrolyte solution into the central portion of the wound electrode body 40 in the width direction TD, and to enhance battery performance (for instance rapid charge and discharge characteristics).

In the third variation all the dots that make up the adhesive layer 336 have substantially the same thickness. In other embodiments, however, the thicknesses of the dots that make up the adhesive layer 336 may be mutually dissimilar. For instance the adhesive layer 336 may have a first dot region and two second dot regions that are thicker than the first dot region. A configuration may also be adopted in which the two second dot regions are disposed at both end portions in the width direction TD, and the first dot region is disposed between the two second dot regions (central portion), such that surface pressure is exerted more readily at the end portions. In the above embodiment and variations thereof, having a dotted adhesive layer, the dots may similarly be prescribed to exhibit different thicknesses. The thickness of the first dot region is preferably from 0.1 to 3.0 μm, more preferably from 0.4 to 1.5 μm. The thickness of the second dot regions is preferably from 0.5 to 8.0 μm, more preferably from 1.0 to 3.5 μm. Studies by the inventors have revealed that in the vicinity of the negative electrode tab group 44, coating sagging gives rise to a reduction in the thickness of the negative electrode active material layer 24, and to a local increase in inter-electrode distance between the positive and negative electrodes. However, by causing a thin portion of the negative electrode active material layer 24 to abut the thick adhesive layer, surface pressure acts more readily as a result on the end portions. In consequence, also the vicinity of the electrode tab can be firmly bonded to the negative electrode plate 20. Variability in battery reactions can be reduced and battery performance (for instance cycle characteristics) can be improved as a result.

In the third variation the dots are formed on the entire surface of the separator 330, but in other implementations dotting may be local. For instance multiple dots may be formed constituting striped shapes, wavy shapes or band shapes, on part of the surface of the separator 330.

Fourth Variation

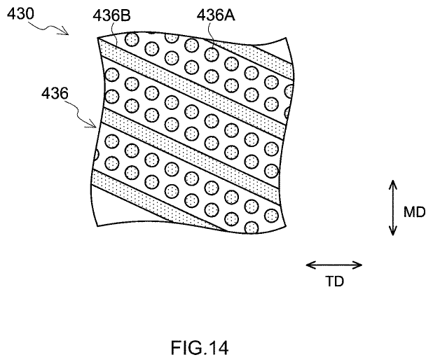

FIG. 14 is a plan-view diagram illustrating schematically a separator 430 according to a fourth variation. The separator 430 may be identical to the separator 30 described above, but herein an adhesive layer 436 includes first regions 436A formed to a dotted shape and second regions 436B formed to a striped shape. The first regions 436A are provided between the lines that make up the stripes of the second regions 436B. The size and spacing of the dots that make up the first regions 436A may be identical to those of the second region 36M of the separator 30. All the dots that make up the adhesive layer 436 have herein substantially the same size. As in the third variation described above, however, dissimilar bonding areas may be set between the end portions and the central portion in the width direction TD, to thereby impart a gradient to the degree of bonding. The width, spacing and inclination angle of the stripes that make up the second regions 436B may be identical to those of the second region 136M of the separator 130. By combining the dotted first regions 436A and the striped second regions 436B, it becomes possible to increase adhesive strength towards the negative electrode plate 20, promote liquid flow in the wound electrode body 40 and suppress gas entrainment in the wound electrode body 40.

What is claimed is:

1. A battery, comprising:
a flat-shaped wound electrode body in which a band-shaped positive electrode, a band-shaped negative electrode and a band-shaped separator are wound in a longitudinal direction; and
a battery case that accommodates the wound electrode body, wherein
the positive electrode has a positive electrode active material layer including a lithium-transition metal complex oxide as a positive electrode active material and a positive electrode binder,
a length w1 of the positive electrode active material layer in a width direction perpendicular to the longitudinal direction is 100 mm or larger,
the negative electrode has a negative electrode active material layer containing graphite as a negative electrode active material,
the separator has a base material layer, a heat-resistant layer opposing the positive electrode, and an adhesive layer opposing the negative electrode,
the heat-resistant layer contains ceramic particles and a heat-resistant layer binder, and a mass ratio of the ceramic particles relative to a total mass of the heat-resistant layer is 90 mass % or higher, and
the adhesive layer contains an adhesive layer binder, and a mass ratio of the adhesive layer binder relative to a total mass of the adhesive layer is 15 mass % or higher.

2. The battery according to claim 1, wherein at least one of the positive electrode binder and the heat-resistant layer binder does not contain a fluorine-based binder that contains fluorine as a constituent element.

3. The battery according to claim 1, wherein
the positive electrode binder contains polyvinylidene fluoride (PVdF),
a mass ratio of the PVdF relative to a total mass of the positive electrode binder, in the positive electrode active material layer, is 50 mass % or higher,
the negative electrode active material layer contains styrene butadiene rubber (SBR) and carboxymethyl cellulose (CMC) as negative electrode binders, in addition to the negative electrode active material, and
a total mass of a mass of the SBR and a mass of the CMC relative to a total mass of the negative electrode binder, in the negative electrode active material layer, is 50 mass % or higher.

4. The battery according to claim 1, wherein
defining a height H of the wound electrode body as a length thereof in a direction perpendicular to a winding axis direction of the wound electrode body and perpendicular to a thickness direction of the wound electrode body,
a ratio (w1/H) of a length w1 of the positive electrode active material layer in a width direction thereof, relative to the height H of the wound electrode body, is 2 or higher.

5. The battery according to claim 1, wherein the adhesive layer includes a region formed to have a dotted shape, in a plan view.

6. The battery according to claim 1, wherein the adhesive layer includes a region formed to have a striped shape, in a plan view.

7. The battery according to claim 1, wherein the adhesive layer has in a plan view, a first region formed to have at least one of a striped shape and a band shape, and a second region formed to have a dotted shape.

8. The battery according to claim 1, wherein
the adhesive layer has, in a plan view, a first region formed to have a band shape extending along the longitudinal direction, and a second region formed to have a dotted shape; and
in a width direction perpendicular to the longitudinal direction, the first region is provided at a pair of end portions of the separator in a width direction thereof, and the second region is provided between the pair of end portions.

9. The battery according to claim 1, wherein
the adhesive layer has, in a plan view, a first region formed to have a band shape extending in the longitudinal direction, and a second region formed to have a striped shape; and
in a width direction perpendicular to the longitudinal direction, the first region is provided at a pair of end portions of the separator in a width direction thereof, and the second region is provided between the pair of end portions.

10. The battery according to claim 1, wherein
upon division of the separator, in a width direction perpendicular to the longitudinal direction, into a pair of end regions and a central region positioned between the pair of end regions,
a basis weight of the adhesive layer is larger in the end regions than in the central region.
